(19) United States
(12) Patent Application Publication
(10) Pub. No.: US 2012/0125759 A1
(43) Pub. Date: May 24, 2012

(54) Vertical Calcined Petroleum Coke Incinerator

(75) Inventors: Charles R. Euston, Hamburg, PA (US); Michael Edward Prokesch, Coopersburg, PA (US); John S. Salmento, Nazareth, PA (US)

(73) Assignee: FLSMIDTH A/S, Valby (DK)

(21) Appl. No.: 12/949,205

(22) Filed: Nov. 18, 2010

(51) Int. Cl. C10B 1/04; F27D 17/00

(52) U.S. Cl. 202/121; 432/72; 432/67

(57) ABSTRACT

A vertically situated incinerator for receiving heated kiln off gases from a petroleum coke calcining process and incinerating volatile matter and carbon fines entrained in the gases. The incinerator also functions as a hot stack through which the gases are vented to atmosphere at times when any downstream equipment for receiving the gases are off line.

### BACKGROUND OF THE INVENTION

Petroleum coke calciners employ rotary kilns to thermally upgrade green coke, thus rendering it suitable for use by the amorphous carbon and graphite industries. During the calcination process of green petroleum coke, volatile matter evaporated from the feed and products of incomplete combustion (including hydrogen and CO), are discharged from the kiln with the process gas along with carbon fines that have been entrained in the kiln gases, at a kiln end opposite of where the calcined carbon particles are discharged. This volatile matter and carbon fines that leaves the kiln must be combusted for environmental and economical reasons, including:
(1) to fully extract the heating value for subsequent steam generation in a waste heat boiler or comparable method of energy recovery;
(2) to prevent discoloration of gypsum produced in subsequent sulfur scrubbers and increase its salability;
(3) to reduce erosion and coating potential in a downstream waste heat boiler or heat exchange device; and
(4) to minimize the emission of particulate and combustible gases from the hot stack when operation in hot stack mode.

The combustion of volatile matter and dust in heated kiln exit gases is done downstream from the kiln, in the direction of gas flow, in a horizontal incinerator. A horizontal incinerator is traditionally used because it is believed that it allows for sufficient material residence time to fully incinerate the carbon particles. The hot gas is thereafter directed to a waste heat recovery boiler to produce steam for use in the process to thereby increase the energy efficiency of the waste production process. Hot gases are drafted through the kiln, incinerator and waste heat boiler by an ID fan located downstream of the waste heat boiler.

Intermediate the incinerator and the waste heat recovery boiler is a vertical “hot stack” that is used to draft the hot gases through the kiln and incinerator and out to atmosphere when down stream gas handling equipment is off line or when there is an upset condition in the waste heat boiler. The hot stack is a separate, free-standing, refractory lined stack and is a very costly item. In using such a conventional separate hot stack, potentially dangerous overpressure can exist in the system until the hot stack comes to an adequate temperature to develop a sufficient draft in the rotary kiln.

There are other disadvantages inherent in prior art coke processing horizontal incinerators. For example, when solid carbon particles fall out of suspension they settle on the floor of the incinerator along its length. Over time this results in piles of unburned material that if not periodically cleaned can result in either or both of (a) uncontrolled flash burning of the settled material, which is hazardous to personnel and equipment; (b) excess load on the floor of the incinerator when fines fall out of suspension which can result in its collapse; and/or (c) a disturbance in the gas flow and combustion profile in the unit, resulting in a deterioration in performance.

Other disadvantages include the need for additional equipment, a larger footprint requirement, additional capital costs, including additional steel and refractory, higher surface heat losses due to larger surface area, potential expansion issues if thermal profile is not uniform, reduced refractory integrity associated with large horizontal vessels, which are all inherent in the requirement of a horizontal incinerator and a separate vertical high temperature stack.

It is therefore an object of the invention to have an incinerator for use in a coke processing facility that does not have the above disadvantages. Another object is to eliminate the need for a separate hot stack in a coke processing facility.

### BRIEF DESCRIPTION OF THE INVENTION

The above and other objectives are achieved by a vertically oriented incinerator that also functions as a hot stack in the process. By partially or completely opening a damper located in the vicinity of the uppermost area of the incinerator during start-up or upset conditions (down stream of the incinerator) some or all of the hot gases can be released to atmosphere via an exterior exhaust pipe that is much smaller in its vertical dimension than the hot stack used with a horizontal incinerator, and in fact such exterior exhaust pipe is too small to function independently as a hot stack. The benefits of the present invention of having the incinerator act as a hot stack include less process equipment, and a smaller foot print for the process due to fewer pieces of equipment. Furthermore, since the incinerator is always hot during kiln production, an instantaneous and stable draft is available after an upset. As indicated, with conventional “separate hot stack” technology, dangerous overpressure exists in the system until the “separate hot stack” comes to temperature. In this respect, the vertical incinerator of the present invention represents a safer design.

Optionally, at the bottom of the incinerator underneath the gas inlet there is a “drop out” chamber for separating coarse coke particles that the kiln and fall out of entrainment in the kiln gases. Any oversized particles that drop out into the chamber are optionally recycled back to the kiln. The dust that does not drop out in the chamber is carried with the gas up into the vertical incinerator. Most of the combustion air in the main body of the vertical incinerator is preferably introduced through a number of ports at a high velocity, preferably with the flow of the process gas. The combustion air is preferably introduced tangentially with the gas flow in the vertical incinerator to induce mixing and combustion of the volatile matter and the burning coke particles and to create a gas swirl which will increase retention time of the particles. Some combustion air or gas from the cooler can be introduced downstream from the main body of the vertical incinerator to further promote combustion of any coke particles or volatile matter that exits the main body of the vertical incinerator.

### DESCRIPTION OF THE DRAWINGS

FIG. 1 is a diagram of the pertinent portions of a prior art coke processing system.

FIG. 2 is a diagram of the pertinent portions of a coke processing system according to the present invention.

FIG. 3 is a more detailed depiction of an incinerator of the present invention. The drawings are not drawn to scale.

### DETAILED DESCRIPTION OF THE INVENTION

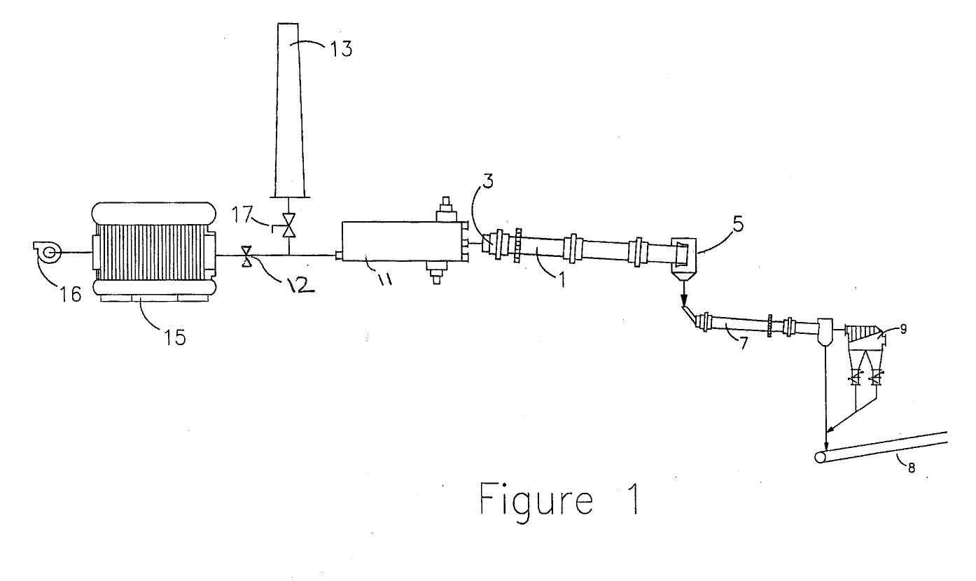

FIG. 1 depicts a prior art coke processing system. Green coke is fed into kiln 1 at elevated end 3 and the process heat enters at lower end 5. As the green coke moves down through the kiln toward lower end 5 due to its rotation, devolatilization and densification takes place during its residence time of between 30 and 90 minutes. The hot calcined coke leaves the kiln at lower end 5 and is transferred to cooler 7 in which it is cooled by cooling gases. The cooled coke is directed to conveying means 8 and the cooling gases are directed to dust collector means 9.

Gases in which there is entrained volatile matter and carbon fines leaves the kiln at upper end 3 and are directed to incinerator 11 to combust the unburned volatiles and dust fines. The hot gases leaving the incinerator are then directed into waste heat boiler 15. Gases are drawn through the system (the kiln, incinerator and boiler) by ID fan 16 located downstream from and flow connected to waste heat boiler 15. Horizontal incinerator 11 is sufficiently long (typically from 60 to about 120 m) to provide the needed residence time to incinerate the carbon fines, typically about 6 to 12 seconds for conventional sized fines.

As depicted, movable damper 17 is shown to be in a closed position with respect to hot stack 13 and damper 12 is in an open position with regard to waste heat boiler 15. During upset conditions when waste heat boiler 15 can not accept the gases, the positions of damper 17 and damper 12 are reversed and damper 17 is open to permit gas to flue to hot stack 13 and damper 12 is closed as to waste heat boiler 15. Hot stack 13 must be of a sufficient height (typically from 40-60 m) and be at a sufficient temperature (approximately 500° C. to about 600° C.) to function as a hot stack, that is, to pull gases through the rotary kiln. Generally, it will take from about 5 to about 15 minutes to bring the hot stack to such sufficient temperatures, during which the system is vulnerable to potentially dangerous overpressure. At the end of the upset conditions gas flow to waste heat boiler 15 is resumed and the position of dampers 17 and 12 are reversed to their positions prior to the upset, that is they are, respectively, open and closed. Alternatively, the system can be designed with a single damper to direct hot gases into either hot stack 13 or waste boiler 15.

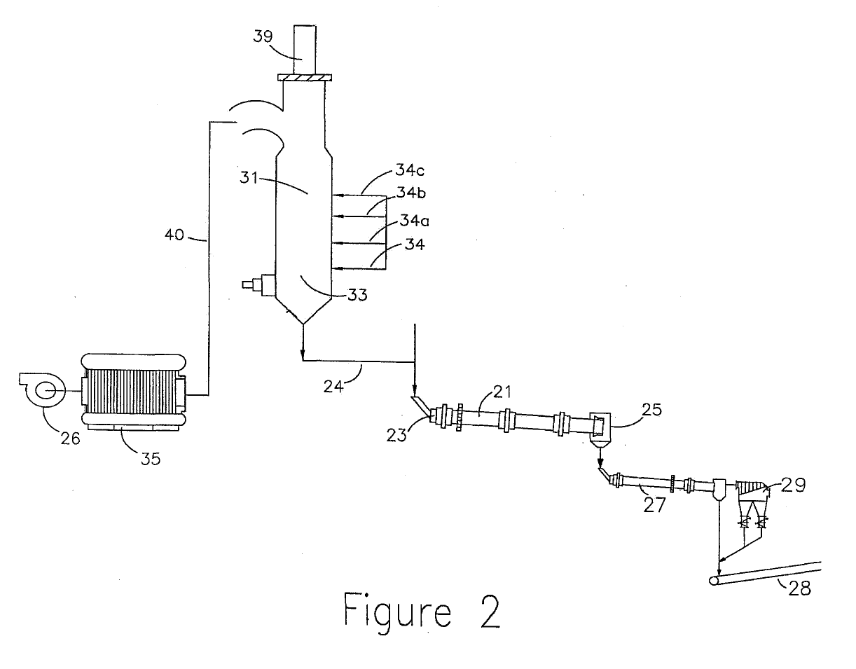

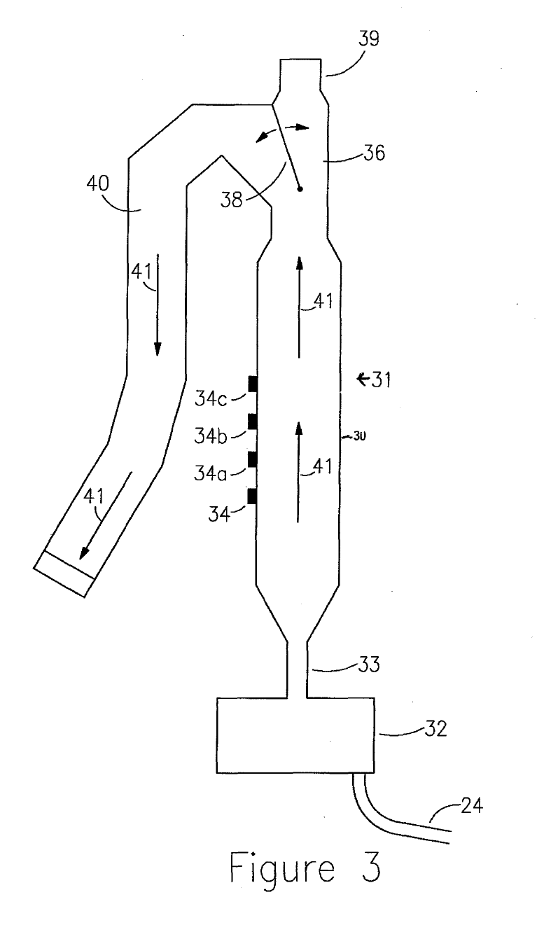

FIG. 2 depicts a coke processing system of the present invention and FIG. 3 shows in greater detail vertically inclined incinerator 31, which is a hollow, essentially cylindrical upright structure having a generally cylindrical outer shell or body 30. In the interior of incinerator 31 gases containing volatiles and smaller carbon fines pass upward in a heated environment to thereby combust the unburned volatiles and dust fines. As in the prior art process, green coke is fed into kiln 21 at elevated end 23 and the process heat enters at lower end 25. Hot calcined coke leaves kiln 21 at lower end 25 and is transferred to cooler 27. The cooled coke is directed to conveying means 28 and the cooling gases are directed to dust collector means 29. Gases in which there are entrained volatile matter and carbon fines to be combusted leave the kiln at upper end 23 and pass through optional drop out chamber 32 which is located at the bottom of vertical incinerator 31 under inlet 33. In optional drop out chamber 32 oversized carbon particles will fall out and accumulate or optionally be directed back to kiln 21 for further calcination, such as via conduit 24. The dust and particles that do not drop out in chamber 32 are carried with the gas up through vertical incinerator 31 via inlet 33. Inlet 33 may optionally have a restricted diameter that is less than the bottom diameter of the incinerator which imparts a venturi effect on the kiln off gases and results in increasing the velocity with which such dust entrained gases enter vertical incinerator 31. After passing through the vertical incinerator 31 and exit duct 40, the rest of the system resembles the prior art, in that the gases are directed into waste heat boiler 35 and the gases are drawn through the system by ID fan 26.

The size of carbon particles that will fall into drop out chamber 32 will depend on design and process parameters such as the incinerator diameter, gas velocities, residence time in vertical incinerator 31, and so on. Generally processes will be designed to have carbon particles larger than about 1.0 mm, and at times larger than only about 0.1 mm, fall into drop out chamber 32.

The terms “vertical” or “vertically inclined” as used herein means that for best performance the incinerator is inclined at an angle of approximately 90 degrees to the horizontal plane, although this angle may be varied to accommodate system layout requirements.

Combustion gases are introduced into incinerator 31 at a high velocity through inlet 34, which is located above the location where the kiln gas having entrained fines enter incinerator 31. Optionally, combustion gas is injected tangentially with the direction in which the process gas/carbon particles moves up through incinerator 31 to induce mixing and combustion of the volatile matter and the burning coke particles by creating a swirl effect which will serve to increase the retention time of the solids entrained in the gas stream. With such an effect, in the event there are larger fines that will take longer to combust, the retention time of solids in the incinerator 31 can be optionally adjusted to be longer than the retention times of process gases in incinerator 31 in order to promote a more complete combustion.

Temperatures in the incinerator will be sufficient to support combustion of the entrained materials, and will typically range from 1000° C. to 1100° C.

Optionally, combustion gas can be introduced through one or more additional ports 34a and so forth to induce better mixing and combustion of the volatile matter and the coke particles. As depicted there are three additional ports 34a, 34b, and 34c. The use of such additional injection ports can also serve to better control the temperature profile along the height of vertical incinerator 31.

At or near the uppermost area 36 of incinerator 31 is movable damper 38 which, during normal operation of the coke processing system of the invention, is closed as to short vertical exhaust pipe 39 that is located direct on top of and is attached to incinerator 31 and leads to atmosphere. Exhaust pipe 39 is much shorter in height than incinerator 31 and in fact does not have sufficient height to independently function as a hot stack in the system. Movable damper 38 is correspondingly open with regard to refractory lined exit duct 40 that leads to waste heat boiler 35. During upset conditions the position of damper 38 may be reversed to be open as to exhaust pipe 39 and closed with regard to refractory lined exit duct 40, thereby bypassing downstream equipment. Alternatively two dampers can be employed to achieve the same effect as described above. Vertical incinerator 31 therefore, in combination with exhaust pipe 39, will alternatively also function as a hot stack, which is necessary in a coke calcining process to vent the hot kiln and combustion gases in the process during start-up and upset conditions down stream of the incinerator, and accordingly such gases will pass through vertical incinerator 31 and exhaust pipe 39 to atmosphere. When damper 38 is closed as to exhaust pipe 39 such gases will pass through incinerator 31 and its associated exhaust duct 40 in the direction of arrows 41.

Vertical incinerator 31 will be of sufficient height (approximately 40 m-60 m) and temperature to function as a hot stack in the system and thereby induce a draft in kiln 21 when ID fan 26 is not on line and damper 38 is open to atmosphere. Although exhaust pipe 39 will be cold at the very start of upset conditions, its size relative to that of vertical incinerator 31 (most preferably approximately 10% of the height of vertical incinerator 31) is such that it will have no effect on the ability of vertical incinerator 31 to immediately induce and maintain a draft in the kiln.

The process gas then exits the incinerator at an elevated temperature and passes downward to the boiler through a refractory lined exhaust duct 40 after a residence time of from about 2 to 10 seconds in the incinerator body. The incinerator exhaust duct 40 is designed to promote additional mixing of the gas stream for improved burn out while also providing additional residence time after the incinerator if needed for further combustion and burnout of the volatile matter and coke dust particles in the gas stream.

The vertical orientation of the incinerator allows for the coarser coke particles in the gas stream to remain suspended in the lower section of the incinerator until burnt down. This results in considerably more residence time for these particles in the vertical incinerator 31 than the residence time of gas in the incinerator, improving burnout and eliminating the handling of additional particle dropout as is required for the horizontal incinerators, without having to extend the height of the vertical calciners. By contrast, extra residence time in a horizontal incinerator is only achieved by extending the length of the horizontal incinerator.

To improve the steam yield or energy recovery from vertical incinerator 31, some combustion air or exhaust gases from cooler 27 may optionally be injected into the upper regions of the vertical incinerator or downstream from the vertical incinerator in duct 40.

While there has been described a particular embodiment of the invention, it will be apparent to those skilled in the art that variations may be made thereto without departure from the spirit of the invention and scope of the appended claims.

What is claimed is:

1. A system for calcining petroleum coke comprising
(a) a kiln for calcining coke having a coke feed end and a calcined coke discharge end and arranged for the passage of heated kiln gases therethrough countercurrent to the travel of coke,
(b) a vertically situated incinerator for incinerating carbon fines and volatile matter entrained in heated kiln gases, said incinerator having a bottom inlet for receiving heated kiln gases from the coke feed end and an upper outlet through which said gases exit; and
(c) a waste heat recovery means adapted to receive the gases exiting the incinerator; and
(d) means for alternately directing gases exiting the incinerator to
(i) the waste heat recovery means or
(ii) to atmosphere, in which case the incinerator functions as a hot stack.

2. The system of claim 1 further comprising means to draft the heated kiln off gases through the kiln, incinerator and waste heat recovery means.

3. The system of claim 2 wherein alternately directing means directs the gases exiting the incinerator to (a) the waste heat recovery means during periods when both the waste heat recovery means and the means to draft the heated kiln off gases are in operation and (b) to atmosphere during periods when either the waste heat recovery means or the means to draft the heated kiln off gases are not in operation.

4. The system of claim 1 wherein there is a dropout chamber situated underneath the bottom inlet for receiving materials that fall out of entrainment.

5. The system of claim 4 further comprising means for recycling the materials that fall out of entrainment from the dropout chamber back to the kiln.

6. The system of claim 1 further comprising a cooler for receiving the calcined coke from the calcined coke discharge end and for cooling said calcined coke;

7. The system of claim 1 wherein the incinerator has an inlet for the heated gases that has a restricted diameter which imparts a venturi effect to the heated gases entering the incinerator.

8. The system of claim 1 wherein the incinerator has one or more inlets through which combustion air enters the incinerator at a direction tangential to the movement of heated gas through the incinerator.

9. A vertically situated incinerator comprising an upright cylindrical body having a hollow interior;
a bottom inlet into the interior of the body for heated kiln gases having entrained therein materials comprising volatile matter and carbon fines;
at least one inlet into the interior of the body for combustion gases;
an exhaust pipe to atmosphere attached to and positioned above the cylindrical body;
means to direct the kiln gases and combustion gases exiting the incinerator to downstream equipment for further treatment of the gases; and
means to direct the kiln gases and combustion gases exiting the incinerator to the exhaust pipe, with said gases that are directed to the exhaust pipe bypassing downstream equipment.

10. The incinerator of claim 9, further comprising a dropout chamber situated underneath the bottom inlet for receiving materials that fall out of entrainment.
